(19) United States
(12) Patent Application Publication
(10) Pub. No.: US 2025/0260122 A1
(43) Pub. Date: Aug. 14, 2025

(54) BATTERY SYSTEM AND MOTOR VEHICLE

(71) Applicant: AUDI AG, Ingolstadt (DE)

(72) Inventors: Martin DEHM, Monheim (DE); Florian KELLER, Gaimersheim (DE)

(73) Assignee: AUDI AG, Ingolstadt (DE)

(21) Appl. No.: 19/016,304

(22) Filed: Jan. 10, 2025

(30) Foreign Application Priority Data
Feb. 9, 2024 (DE) 102024103653.2

(51) Int. Cl. H01M 50/367; H01M 50/204; H01M 50/249

(52) U.S. Cl. CPC H01M 50/367; H01M 50/204; H01M 50/249; H01M 2220/20

(57) ABSTRACT

A battery system with multiple battery cells and a base plate supporting the battery cells. The battery cells each have a cell housing with a cell vent which is designed to open when a predetermined limit pressure is exceeded. The base plate has a number of degassing openings corresponding to the number of battery cells, which, when viewed in the normal direction of the base plate, completely penetrate the base plate. The degassing openings and the battery cells are arranged relative to one another such that the cell vent of each battery cell is positioned opposite one of the degassing openings. A support plate is arranged between the base plate and the battery cells, which support plate has recesses arranged corresponding to the degassing openings and extending into the degassing openings as viewed in the normal direction N.

### FIELD

The invention relates to a battery system of the type specified in the preamble of claim 1 and to a motor vehicle according to claim 10.

### BACKGROUND

Battery systems for electric vehicles or high-voltage batteries for electric vehicles are well known from the prior art and comprise a large number of individual battery cells, in particular lithium-ion battery cells.

A known challenge of such high-voltage batteries or battery systems for electric vehicles is that internal local overheating in a battery cell, e.g. due to a short circuit in the battery cell caused by an internal cell defect, can lead to thermal runaway of the battery cell, which in turn can lead to overheating and short circuits and thus to thermal runaway of neighboring cells. The chain reaction-like propagation to neighboring battery cells, also known as thermal propagation, must be avoided, as this can lead to a fire in the entire high-voltage battery or the entire battery system and thus represents a considerable safety risk for the occupants of the electric vehicle.

For preventing a fire and/or explosion of a battery cell in case of thermal runaway, it is known to provide a predetermined rupture point in the cell housing of a battery cell, which rupture point is designed to rupture when a predetermined limit pressure in an interior of the cell housing is exceeded and to allow a gas and/or fire jet to escape from the interior of the cell housing, see DE 10 2020 102 221 A1. The rupture point, also referred to as cell vent, can be designed in different ways, e.g. in the form of a burst membrane, or similar to a door on one hinge or a saloon door on two hinges.

A generic battery system, according to which the battery cells each have a degassing opening and are arranged on a base plate in such a way that the degassing openings are aligned with corresponding passages made in the base plate, is disclosed in DE 10 2009 046 385 A1.

### SUMMARY

The object of the invention is to develop a battery system of the type specified in the disclosure in such a way that in the event of a thermal runaway of a battery cell of the battery system, a propagation to neighboring battery cells, namely a thermal propagation, is prevented. The battery system according to the invention comprises, in a known manner, multiple battery cells and a base plate carrying the battery cells. While the battery cells each have a cell housing with a cell vent that is designed to open when a predetermined limit pressure is exceeded, the base plate has a number of degassing openings that corresponds to the number of battery cells and thus to the number of cell vents, which openings, viewed in the normal direction N of the base plate, completely penetrate the base plate. The venting openings and the battery cells are arranged in such a way that the cell vent of each battery cell is positioned in alignment with and opposite one of the venting openings.

The above term “battery cell” is not to be understood as limiting the battery cells to a specific design. This means that the battery cells can be designed as round cells, as prismatic cells or pouch cells.

For the sake of completeness, it should also be noted that the normal direction N is not to be understood as restrictive with regard to the installed state of the battery system in a vehicle. This means that, with respect to a vehicle-fixed coordinate system the x-axis of which runs along the vehicle's longitudinal axis and points in the direction of travel (=forward travel direction), the y-axis of which runs along the vehicle's transverse axis and points to the left accordingly and the z-axis of which is aligned upwards along the vehicle's vertical axis, the battery system according to the invention can be arranged such that the normal direction N points in the x, y or z-direction of the vehicle-fixed coordinate system.

The battery system according to the invention is characterized in that a support plate is arranged between the base plate and the battery cells, which support plate has recesses arranged corresponding to the degassing openings and extending into the degassing openings as viewed in the normal direction N, wherein the support plate is designed in the region of the recesses such as to fail when a predetermined boundary condition is exceeded and thus to open the degassing openings.

In this case, predetermined boundary conditions are understood to mean, in particular, temperature and/or pressure. This means that if a predetermined temperature and/or a predetermined pressure is exceeded, the support plate in the area of the recesses specifically fails, thus opening up the degassing openings.

The support plate provided according to the invention proves to be particularly advantageous since—in the event of a thermal runaway of a battery cell—it acts as a protective shield for neighboring battery cells and thus successfully prevents a chain reaction-like propagation to neighboring battery cells of the battery system. The recesses provided according to the invention have the effect that—in the event of a thermal runaway of a battery cell—a receiving space is provided for the material displaced from the cell housing when the cell vent is opened, so that the risk of block formation in front of the cell vent is reduced. A further advantage of the recesses is that they also form a compensation volume for the hot gas flow that essentially escapes in the first phase of a thermal runaway, so that an immediate pressure reduction in the cell housing of the thermally runaway battery cell is ensured, with the effect that the risk of the cell housing of the thermally runaway battery cell opening at a location other than the cell vent is reduced. Another advantage is that it is ensured that the sensitive cell vent region of the cell housing is not exposed to assembly forces during assembly.

Preferably, the recesses of the support plate each have at least one local material taper which is dimensioned to fail, i.e. to melt and/or burst, when the predetermined boundary condition is present, in particular when a predetermined temperature and/or a predetermined pressure is exceeded. The advantage of this embodiment is that corresponding material tapers can be implemented easily and therefore cost-effectively.

Another embodiment provides that the recesses of the support plate have at least one predetermined breaking line which is designed to fail when the predetermined boundary condition is present. Failure along a predetermined breaking line has the effect of allowing large-area breakage of the recesses. The predetermined breaking line can, for example, be designed in the form of a perforation.

The support plate is preferably made of a plastic, in particular fiber-reinforced plastic, However, it is also conceivable to design a structure made of metal or a composite material.

A further embodiment is characterized in that the recesses have a protective material on their side facing away from the degassing openings. The applied protective material has the effect of ensuring better resistance to gas/particle bending from below and thus—in the event of a thermal runaway—improving the desired protective shield function for neighboring battery cells.

In order to ensure that the cell vent can open mechanically cleanly in the event of a thermal runaway, a particularly preferred embodiment provides that the recesses of the support plate are each trough-shaped, having a bottom surface arranged at a clear distance from the associated cell vent, and in that the recesses, when viewed in the normal direction N, are dimensioned such that the clear distance is greater than a cell housing portion in its maximum extension direction that breaks out of the cell housing when the cell vent is opened.

The clearance required for clean mechanical opening depends in particular on the specific design of the cell vent, which—as already mentioned—can be designed, for example, in the form of a bursting membrane, similar to a door on one hinge or a saloon door on two hinges or the like. However, as initial tests have shown, the clearance should be between 4 mm and 6 mm.

To ensure targeted discharge of the dangerous gas escaping in the event of a thermal runaway, the base plate has a degassing channel on the side facing away from the support plate, into which the degassing openings open. Particularly preferred is an arrangement according to which the battery system is installed in such a way that the normal direction N is aligned in the z-direction of the vehicle-fixed coordinate system. This means that the degassing channel is arranged below the base plate in the z-direction, when viewed in the vertical direction of the vehicle. This advantageously ensures that in the event of a thermal runaway, the degassing occurs downwards and thus away from the passengers.

To ensure adequate protection against moisture during normal driving, the degassing channel is preferably designed with a closed cross-section.

In order to enable sufficient cooling of the battery system, a further embodiment provides that the base plate has at least one cooling bore aligned orthogonally to the normal direction N, through which a cooling medium can flow.

A further preferred embodiment is characterized in that a first and/or second sealing element arranged on the support plate is assigned to the degassing openings, wherein, when viewed in the longitudinal direction L of the degassing openings arranged in a row, the first sealing element is assigned to the edge regions of the degassing openings oriented perpendicular to the longitudinal direction L and the second sealing element is assigned to the edge regions of the degassing openings oriented in the longitudinal direction L. The advantage of this design is that the sealing elements hinder an unwanted outgassing, i.e. the escape of “transverse gas”, which propagates beneath the battery cell before the targeted failure or opening of the recesses and/or after the opening of the recesses, as well as degassing into the HV space, which is often used for electrical connections of the battery cells. A further advantage is that the sealing elements ensure clean support/contact between the battery cells and the support plate.

A further object of the invention is to develop a motor vehicle, in particular an electric vehicle, which comprises a battery system, in such a way that in the event of a thermal runaway of a battery cell of the battery system, further damage to the vehicle is prevented as far as possible.

This object is achieved in that the battery system is designed according to any one of claims 1 to 9.

All embodiments of the battery system according to the invention may be transferred analogously to the motor vehicle according to the invention, so that the above-mentioned advantages can be achieved thereby.

### BRIEF DESCRIPTION OF THE FIGURES

Further advantages and possible uses of the invention will be apparent from the following description in conjunction with the exemplary embodiment depicted in the drawing.

In the figures:

FIG. 1 shows a sectional view of a first embodiment of the battery system according to the invention;

FIG. 2 shows a second embodiment of the battery system according to the invention in a sectional view, and

FIG. 3 shows a sectional view of the battery system according to the invention according to a third embodiment.

### DETAILED DESCRIPTION

In the following description and in the figures, to avoid repetition, identical parts and components are marked with the same reference numerals unless further differentiation is necessary or useful.

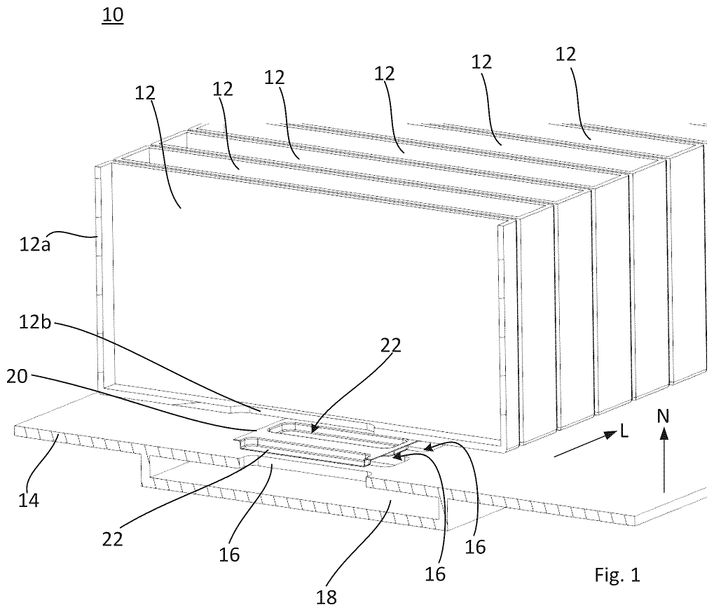

FIG. 1 to FIG. 3 show a battery system, designated overall by the reference number 10, in an exploded view. The battery system 10 essentially comprises a plurality of battery cells 12 and a base plate 14 supporting the battery cells 12. The normal direction of the base plate 14 is designated by the reference symbol N.

The base plate 14 of the battery system 10 has a number of degassing openings 16 corresponding to the number of battery cells 12, which, viewed in the normal direction N, completely penetrate the base plate 14 and open into a degassing channel 18 which is closed in cross-section. As can be seen from FIGS. 1 to 3, the degassing openings 10 are arranged in a row; the longitudinal direction L of the degassing openings arranged in a row is designated by the reference L.

The battery cells 12 each have a cell housing 12a with a cell vent 12b, which is designed to open when a predetermined limit pressure is present and thus to enable degassing of the battery cells 12. The battery cells 12 and the degassing openings 16 are arranged in such a way to each other that the cell vent 12b of each battery cell 12 is positioned in alignment with and opposite one venting opening 16.

As can be further seen from FIG. 1 to FIG. 3, the battery system 10 according to the invention also comprises a support plate 20 arranged between the base plate 14 and the battery cells 12. What is particularly characteristic of the support plate 20 is that it has recesses 22 arranged corresponding to the degassing openings 16 and extending into the degassing openings 16 when viewed in the normal direction N.

In the present case—as shown in FIG. 1 to FIG. 3—the degassing openings 16 are designed in the form of elongated holes and the recesses 22 accordingly have a trough shape following the elongated hole-like contour of the degassing openings 16.

The support plate 20 is designed such that when a predetermined boundary condition is exceeded, in particular when a predetermined temperature and/or a predetermined pressure is exceeded, the support plate 20 fails in the region of the recesses 22 in a targeted manner and the degassing openings 16 are thus opened.

In the present case, the recesses 22 have corresponding material tapers which are dimensioned in such a way that—in the event of a thermal runaway—they melt away in a targeted manner due to the hot particle flow that occurs, thus causing a targeted failure.

The support plate 22 has the effect that—in the event of a thermal runaway of a battery cell 12—it acts as a protective shield for neighboring battery cells 12, so that a chain reaction-like propagation to neighboring battery cells 12 of the battery system 10 and thus thermal propagation is successfully prevented.

A further advantage is that the recesses 22 ensure that—in the event of a thermal runaway of a battery cell 12—a receiving space is provided for the material displaced from the cell housing 12a when the cell vent 12b is opened, so that the risk of block formation in front of the cell vent 12b is reduced.

A further advantage of the recesses 22 is that they also form a compensation volume for the hot gas flow that essentially escapes in the first phase of a thermal runaway, so that an immediate pressure reduction in the cell housing 12a of the thermally runaway battery cell 12 is ensured, with the effect that the risk of the cell housing 12a of the thermally runaway battery cell 12 opening at a location other than the cell vent 12b is reduced.

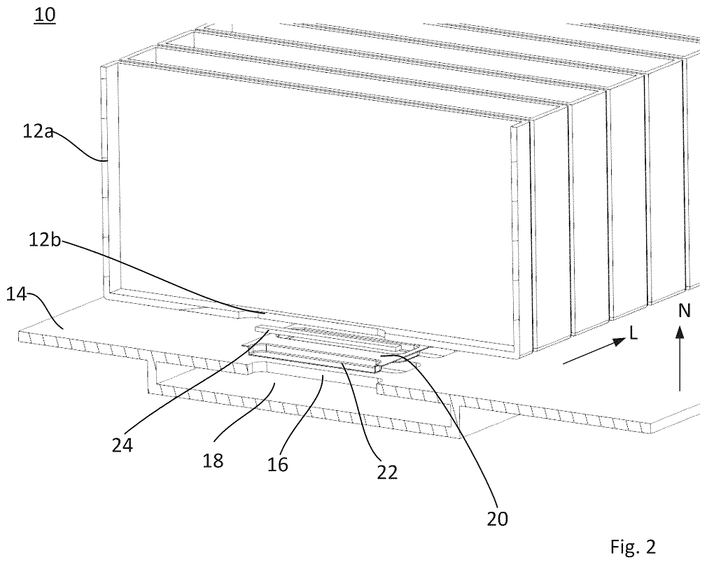

The second embodiment shown in FIG. 2 essentially corresponds to the embodiment shown in FIG. 1.

The embodiment shown in FIG. 2 is characterized in particular in that, when viewed in the longitudinal direction L, a first sealing element 24 arranged on the support plate 20 is assigned to the longitudinal sides of the elongated hole-like degassing openings 16. The sealing elements 24 arranged between the battery cells 12 provide an improved sealing effect, so that—in the event of a thermal runaway—unwanted outgassing or leakage of “transverse gas”, namely gas which may propagate before the deliberate failure or opening of the recesses 22 below the thermally runaway battery cell 12, is made more difficult. A further advantage is that the sealing elements 24 have a tolerance-compensating effect, which in particular also ensures improved support/contact of the battery cells 12 on the support plate 10.

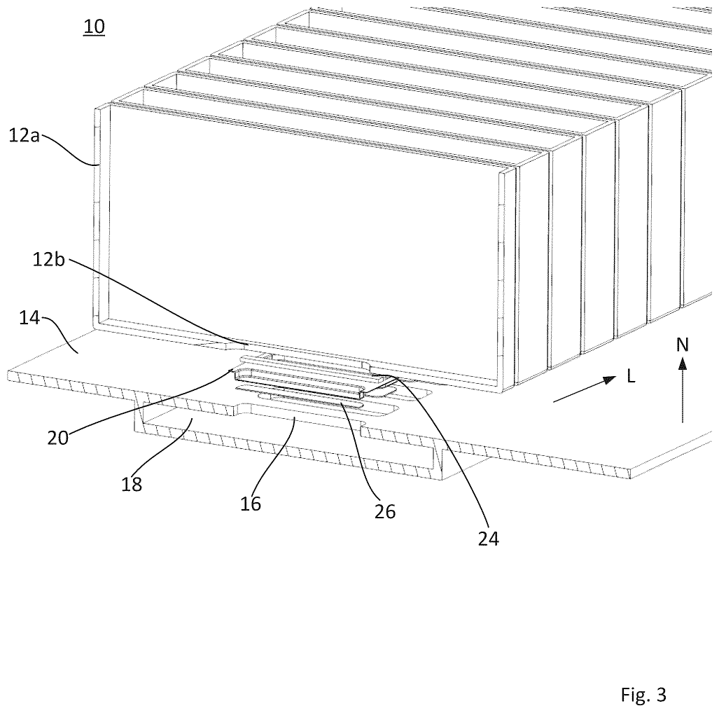

The second embodiment shown in FIG. 3 essentially corresponds to the embodiment shown in FIG. 2.

A characteristic feature of the embodiment shown in FIG. 3 is that a protective material 26 is applied to the side of the recesses 22 facing away from the degassing openings 16. The protective material 26 ensures that the rear sides of the recesses 22 have a higher resistance to gas/particle reflections, so that—in the event of a thermal runaway of a battery cell 12—the desired protective shield function for neighboring battery cells 12 is improved.

1. A battery system, comprising: multiple battery cells and a base plate supporting the battery cells, wherein the battery cells each have a cell housing with a cell vent which is designed to open when a predetermined limit pressure is exceeded, wherein the base plate has a number of degassing openings corresponding to the number of battery cells, which, when viewed in the normal direction of the base plate, completely penetrate the base plate, wherein the degassing openings and the battery cells are arranged relative to one another such that the cell vent of each battery cell is positioned opposite one of the degassing openings,
a support plate is arranged between the base plate and the battery cells, which support plate has recesses arranged corresponding to the degassing openings and extending into the degassing openings as viewed in the normal direction N, wherein the support plate is designed in the region of the recesses such as to fail when a predetermined boundary condition is exceeded and thus to open the degassing openings.

2. The battery system according to claim 1, wherein the recesses of the support plate each have at least one local material taper which is dimensioned to fail when the predetermined boundary condition is present.

3. The battery system according to claim 1, wherein the recesses of the support plate have at least one predetermined breaking line which is designed to fail when the predetermined boundary condition is present.

4. The battery system according to claim 1, wherein the recesses have a protective material on their side facing away from the degassing openings.

5. The battery system according to claim 1, wherein the recesses of the support plate are each trough-shaped, having a bottom surface arranged at a clear distance from the associated cell vent, and that, viewed in the normal direction, the recesses are dimensioned such that the clear distance is greater than a cell housing portion in its maximum extension direction that is to break out of the cell housing when the cell vent is opened.

6. The battery system according to any one of claim 1, wherein the base plate has on its side facing away from the support plate a degassing channel into which the degassing openings open.

7. The battery system according to claim 6, wherein the degassing channel has a closed cross section.

8. The battery system according to claim 1, wherein the base plate has at least one cooling bore aligned orthogonally to the normal direction through which a cooling medium can flow.

9. The battery system according to claim 1, wherein a first and/or second sealing element arranged on the support plate is assigned to the venting openings, wherein, when viewed in the longitudinal direction of the venting openings arranged in a row, the first sealing element is assigned to edge regions of the venting openings aligned perpendicular to the longitudinal direction and the second sealing element is assigned to the edge regions of the venting openings aligned in the longitudinal direction.

10. A motor vehicle comprising a battery system, characterized in that the battery system is designed according to claim 1.

11. The battery system according to claim 2, wherein the recesses of the support plate have at least one predetermined breaking line which is designed to fail when the predetermined boundary condition is present.
